(19) United States
(12) Patent Application Publication
(10) Pub. No.: US 2005/0115086 A1
(43) Pub. Date: Jun. 2, 2005

(54) Hacksaw with support arm

(76) Inventor: Christian E. Wilkey, Lowell, MA (US)

Correspondence Address: KENNETH W. MOODY, 2136 7TH AVE SW, PUYALLUP, WA, 98371, US

(21) Appl. No.: 10/722,388

(22) Filed: Nov. 28, 2003

(51) Int. Cl. B23D 51/01

(52) U.S. Cl. 30/517; 30/514; 30/506

(57) ABSTRACT

The Hacksaw with support arm includes a frame having an elongated top portion extending along an axis generally from the front to the back of the frame, a front leg extending from said the axis and a back leg extending from the axis, the legs having means for supporting a blade from distal ends thereof. A support arm slidingly engages the elongated top portion. The support arm is extensible rearwardly of the back leg in the direction of the axis. The support arm includes an arm support for resting against a user's forearm during use.

### BACKGROUND OF THE INVENTION

1. Field of the Invention

The present invention relates to hacksaws. In particular, the present invention relates to a hacksaw having a retractable support arm to protect the user's wrist.

2. Description of the Related Art

Hand tools often require that downward pressure be placed on the tool using the muscles of the wrist and hand while at the same time maintaining the orientation of the extended tool by applying a moment about an axis perpendicular to the handle and the user's forearm. This places an inordinate amount of stress on the user's wrist and can be painful if such stress is prolonged.

There have been many attempts at relieving the stress associated with such tools, but they are generally bulky and impractical.

For example, U.S. Pat. No. 4,941,261, issued Jul. 17, 1990 to Glenn, discloses a knife with an integrally-formed support arm. The support arm extends to the forearm of the person holding the knife and thereby maintains the orientation of the knife with respect to the arm during use. Since it is less stressful to simply push down on the handle than to push down on the handle while at the same time keeping the knife pointed out from the arm, the support arm significantly reduces the stress associated with using the knife. However, the support arm is not adjustable for various users, nor is it retractable.

U.S. Design Pat. D463,083, issued Sep. 17, 2002 to Kari et al., discloses an ice scraper having a support arm. Again, the wrist brace is neither adjustable nor retractable.

U.S. Pat. No. 5,379,758, issued Jan. 10, 1995 to Snyder discloses a surgical retractor having an extended support arm. A fulcrum is created at the attachment between the hand grip and the handle so that stronger muscles of the user are available with a mechanical advantage instead of relying on the wrist muscles.

U.S. Pat. No. 5,471,700, issued Dec. 5, 1995 to Pereira, discloses a grill scraping tool having a forearm embracing portion at the proximal end. The tool purportedly protects the user against burning and requiring only one hand to generate sufficient leverage against the grill surface.

Finally, U.K. Patent Application GB 2,248,034, published Mar. 25, 1992 by Anderson, discloses a shovel handle adapted for use with one arm by providing a forearm support structure.

Accordingly, the prior art as a whole teaches the concept of providing a hand tool with a support arm extending to a user's forearm to leverage the stronger muscles in the arm thereby reducing strain on the wrist. However, they fail to show a hand tool having a support arm that is easily retractable or repositionable to suit a variety of different users.

Thus, none of the above inventions and patents, taken either singly or in combination, is seen to describe the instant invention as claimed. A hacksaw with support arm solving the aforementioned problems is desired.

### SUMMARY OF THE INVENTION

The hacksaw with support arm includes a frame having an elongated top portion extending along an axis generally from the front to the back of the frame, a front leg extending from said the axis and a back leg extending from the axis, the legs having means for supporting a blade from distal ends thereof. A support arm slidingly engages the elongated top portion. The support arm is extensible rearwardly of the back leg in the direction of the axis. The support arm includes an arm support for resting against a user's forearm during use.

Accordingly, it is a principal object of the invention to provide a hacksaw that requires less strain and effort than previous hacksaws.

It is another object of the invention to provide a support arm for a hacksaw that adjusts to improve the comfort and reduce wrist strain for a variety of users.

It is a further object of the invention to provide a hacksaw with an extensible support arm that can be retracted or extended depending on the preference of the user.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a hacksaw with support arm according to an embodiment of the present invention.

FIG. 2 is a perspective view of the hacksaw of FIG. 1 showing salient features thereof.

FIG. 3 is partial cut-away view of the hacksaw of FIGS. 1 and 2 showing the latch adjustment mechanism.

Similar reference characters denote corresponding features consistently throughout the attached drawings.

### DETAILED DESCRIPTION OF THE PREFERRED EMBODIMENT

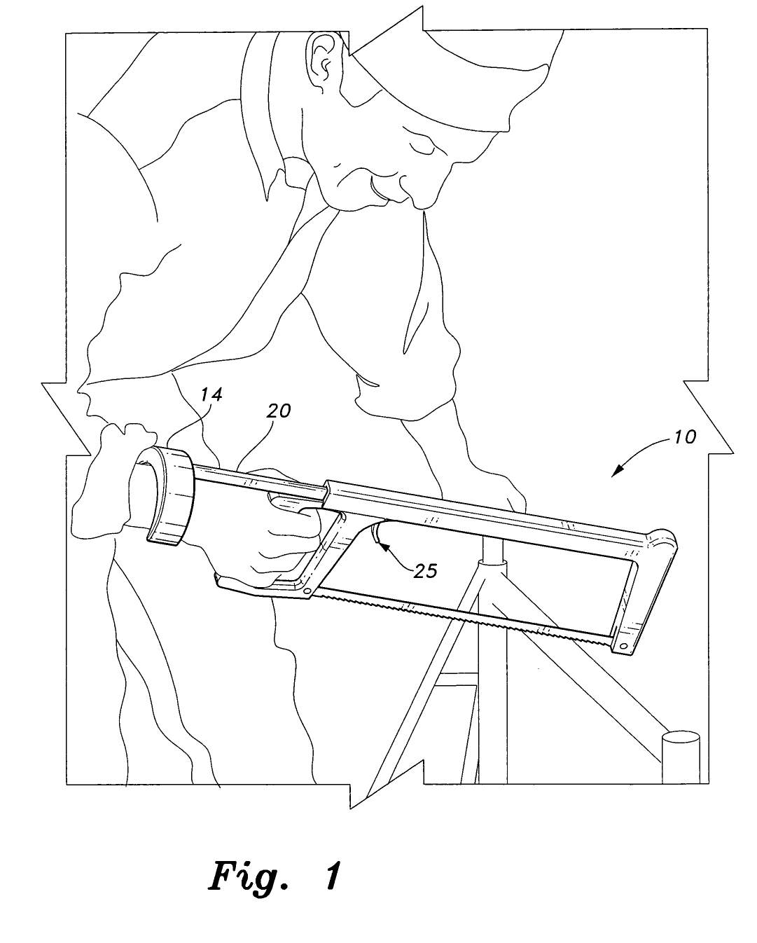

FIG. 1 shows a hacksaw 10 having an extensible arm 20 to relieve wrist strain. As will be described in detail below, extensible arm 20 is adjustable and fully retractable so that hacksaw 10 may be used as an ordinary hacksaw or as one with added the advantages of an adjustable support arm.

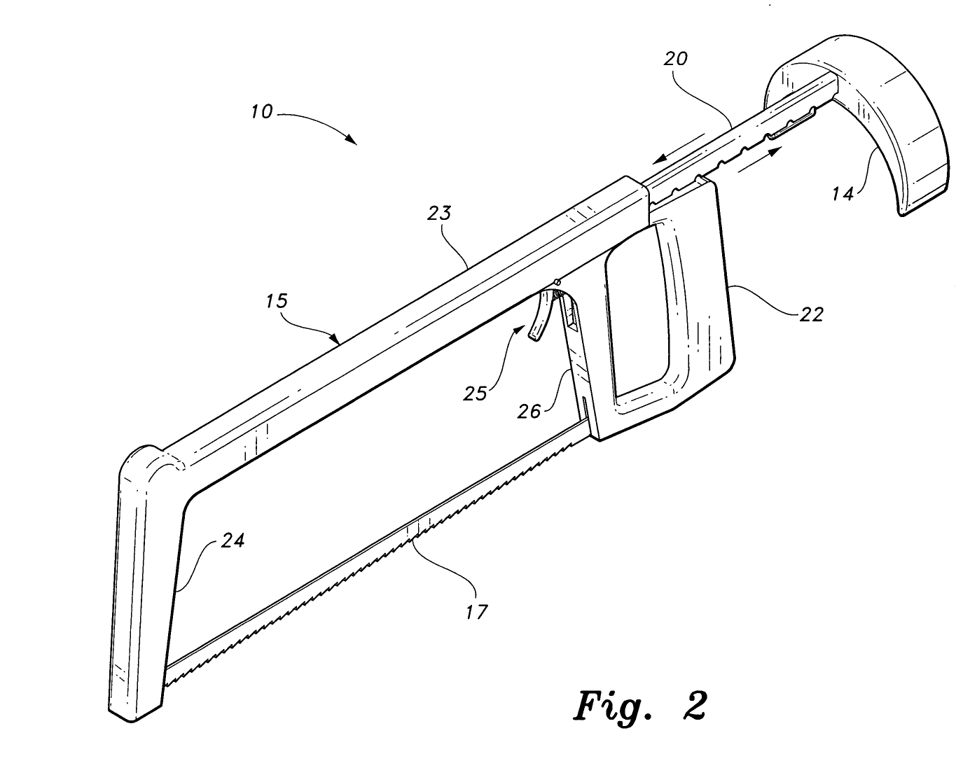

Referring now to FIG. 2, hacksaw 10 includes a frame 15 supporting blade 17 in any known manner. Frame 15 includes an elongated top portion 23 extending generally along an axis, a front leg 24 extending away from the axis of top portion 23, and a back leg 26 also extending away from the axis of top portion 23. Front leg 24 and back leg 26 may extend generally perpendicularly from top 23 to form C-shaped frame 15. Blade 17 is retained by and extends between distal ends of front leg 24 and back leg 26 of frame 15 as is generally known and understood in the art.

Hacksaw 10 also includes a handle 22. Handle 22 is fixed to and extends from top portion 23 behind back leg 26 thereby providing a space for a user's fingers to wrap around handle 22, as shown in FIG. 1. Handle 22 is connected to frame 15 at the top of handle 22 and to the distal end of back leg 26. However, it is also contemplated that handle may be attached only at its top to frame 15, as is known in the art and sometimes referred to as a “pistol grip.” It is also contemplated that back leg 26 may double as a handle such that a separate handle 22 is not needed. Frame 15 and handle 22 are preferably made of metal or composite material and may manufactured by any generally known method. Handle 22 may also be made of plastic or other suitable moldable material. For example, frame 15 may be made of cast aluminum or aluminum alloy and handle 22 made of impact-resistant plastic.

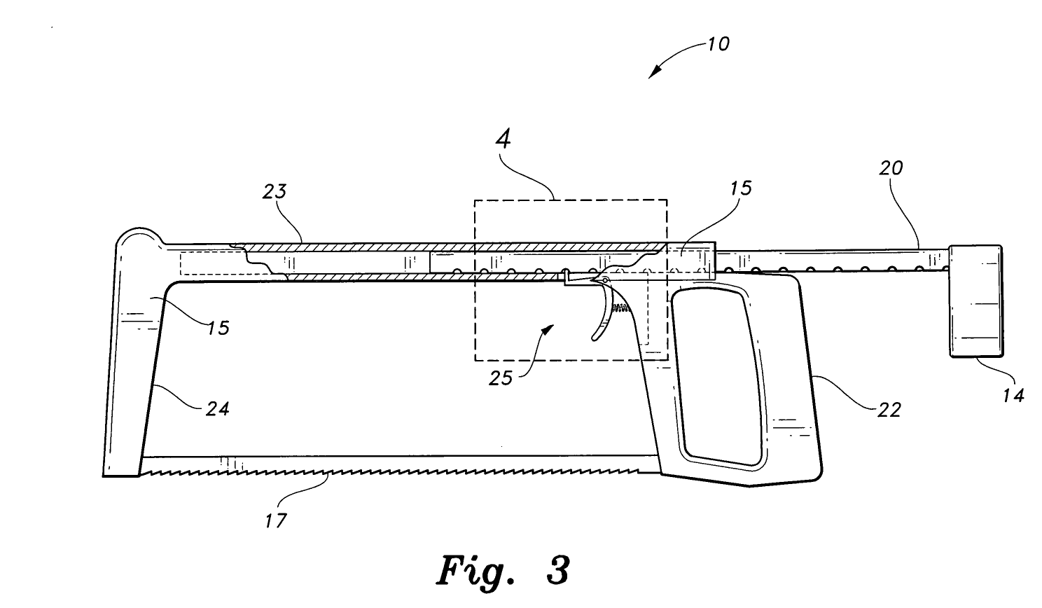

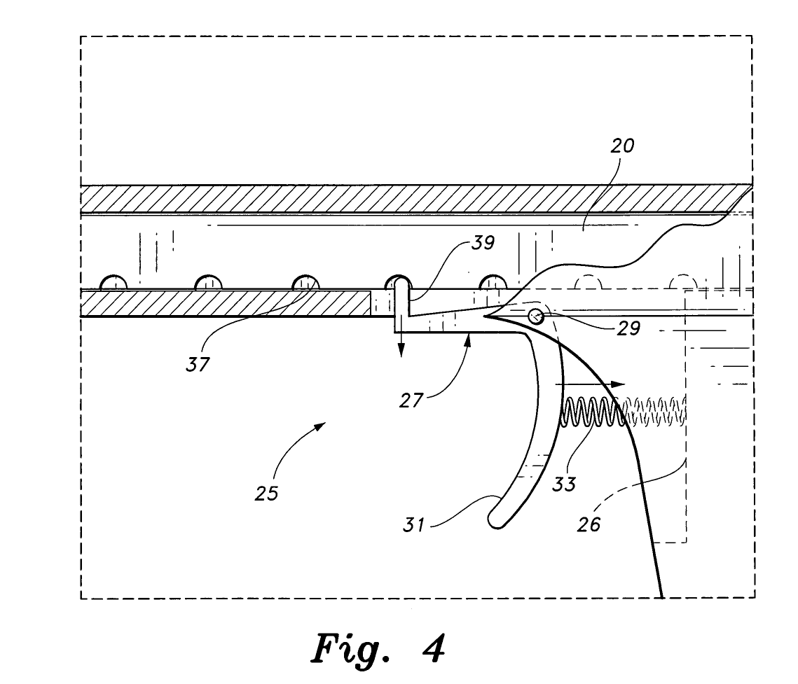

Referring now to FIG. 3, top 23 slidingly receives extensible arm 20 which has a U-shaped cross-section with the legs of the “U” pointing down towards the blade. Note that, while extensible arm 20 preferably has a U-shaped cross-section, other cross-sections are possible. For example, extensible arm 20 may be formed from a simple strip of metal or other stiff material lying generally in the plane of blade 17. However, to increase lateral strength, it is preferred that arm 20 have significant lateral dimension. For example, extensible arm 20 may have an angle-shaped cross section, T-shaped cross, section, I-shaped cross section, etc. Extensible arm 20 may also be formed from a solid rod, bar, or hollow tube. Thus, the actual shape of extensible arm 20 may depart from the preferred shape without departing from the spirit and scope of the invention.

A trigger-actuated latch mechanism 25 is conveniently provided just forward of back leg 26. Referring now to FIG. 4, latch mechanism 25 includes a latch 27 including a trigger portion 31, a latching portion 39 a pivot 29 and a spring 33. Latch 27 is preferably formed of moldable material such as plastic or metal.

Spring 33 is shown as a coiled compression spring, however springs of other shapes are contemplated. For example, spring 33 may be formed of plastic and molded integrally with latch 27. Spring 33 therefore urges latch 27 to rotate in a clockwise direction about pivot 29 as shown in FIG. 4 by biasing against wall 26 formed in frame 15. Pivot 29 may comprise a pin extending through frame 15 and latch 27.

Latching portion 39 is therefore biased by said spring to engage notches 37 formed in a lower edge of extensible arm 20. To release latching portion 39 from one of notches 37, the user simply pulls on trigger 31, overcoming the force generated by spring 33 to rotate latch 27 counter-clockwise about pivot 27 thereby disengaging latching portion 39 from notch 37. The user is then free to retract, extend, or reposition extensible arm 201. Once extensible arm 20 is in the desired position, trigger 31 is released and latching portion 39 will engage a notch 37 upon alignment of latching portion 39 with one of notches 37.

Hacksaw 10 may therefore be used with extensible arm 20 in the fully retracted state where it looks and operates just like an ordinary hacksaw. However, when extended or rigorous use is anticipated, the user may depress trigger 31 and extend retractable arm 20 it to any of a plurality of degrees of extension thereby providing a support arm having a comfortable length to suit any user. By allowing arm support 14 to rest against the user's forearm, hacksaw 10 may be used with significantly less strain on the user's wrist.

It is to be understood that the present invention is not limited to the embodiment described above, but encompasses any and all embodiments within the scope of the following claims.

1. A hacksaw with support arm, comprising:
a frame having an elongated top portion extending along an axis generally from a front of said frame to a rear of said frame;
a front leg extending from said axis and a back leg extending from said axis, said front leg and said back leg having means for supporting a blade from distal ends of said front leg and said back leg; and
a support arm slidingly engaged to said top portion, said support arm extending rearwardly from said top portion in the direction of said axis, said support arm including an arm support for resting against a user's forearm during use of said hacksaw.

2. The hacksaw of claim 1 further comprising means for receiving said support arm on said frame such that said support arm is slideable to a plurality of degrees of extension.

3. The hack saw of claim 2 wherein said means for that said support arm is coextensive with said upper portion.

4. The hacksaw with support arm according to claim 1, wherein said frame includes a support arm housing that slidingly receives said extensible support arm.

5. The hacksaw of claim 1 further comprising a latch mechanism to lock said support arm in at least one extended position.

6. The hacksaw of claim 5 wherein said latch includes a latching portion that engages a notch formed in said support arm when said support arm is locked.

7. The hacksaw of claim 6 wherein said latch includes a trigger portion in mechanical communication with said latching portion such that when said trigger portion is pulled, said latching portion is released from said notch.

8. The hacksaw of claim 7 wherein said latch further includes a pivot located between said trigger and said latching portion.

9. The hacksaw of claim 6 further comprising a spring biasing said latching portion toward said notch, thereby maintaining said latching portion in engagement with said notch when said support arm is locked.

10. The hacksaw of claim 1 wherein said support arm is formed with a U-shaped cross section, wherein the legs of the U point in the direction said back leg.

11. The hacksaw of claim 1 further comprising a handle disposed rearwardly of said back leg, said handle extending down from said top portion.

12. The hacksaw of claim 11 wherein said handle is attached at its top end to said top portion and at its bottom end to said back leg.

13. A hacksaw having a support arm, the hacksaw comprising:
a frame having an elongated portion and two leg portions extending away from an axis of said elongated portion, the leg portions including means for supporting a blade therebetween at distal ends of said leg portions; and
a support arm slidingly engaged to said elongated portion and extensible between a retracted position in which said support arm is coextensive with said elongated portion and an extended position in which said support arm extends rearwardly of a back one of said legs, said support arm including a forearm

14. The hacksaw of claim 13 wherein said forearm support includes a pair of wings extending out and down from said support arm to form a segment of an arm cuff for comfortably resting against the upper side of a person's forearm.

15. The hacksaw of claim 14 wherein said forearm support further comprises padding fixed to an underside of said pair of wings.

16. The hacksaw of claim 13 further comprising:
a latch having means for locking said support arm in one of an extended and retracted position.

17. The hacksaw of claim 16 wherein said support arm includes a notch and said latch comprises a latching portion biased by a spring to engaged said notch when said notch is aligned with said latching portion, thereby locking said support arm in a position corresponding with said alignment.

18. The hacksaw of claim 17 herein said support arm includes a plurality of notches along a length of said support arm allowing said latch to lock said support arm into a plurality of degrees of extension.

19. The hacksaw of claim 17 wherein said latch is pivotally mounted to said frame by a pin extending through said frame and said latch, said spring urges said latch to rotate about said pivot thereby biasing said latching portion toward said support arm.

20. The hacksaw of claim 19 wherein said latch further comprises a trigger positioned forward of said back leg, said trigger being fixed to said latching portion with said pivot being positioned between said latching portion and said trigger such that when said trigger is pulled, said latch rotates on said pivot in a direction counter to said bias of said spring, thereby releasing said latching portion from said notch.
